(19) United States
(12) Patent Application Publication
(10) Pub. No.: US 2003/0101229 A1
(43) Pub. Date: May 29, 2003

(54) Apparatus and method for a network copying system

(76) Inventors: Ming Se Teng, Hsin Chu City (TW); Chee-Kong Chong, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/991,672

(22) Filed: Nov. 26, 2001

(51) Int. Cl. G06F 15/173

(52) U.S. Cl. 709/217; 709/230

(57) ABSTRACT

A network copying system includes at least one host computer and at least one machine unit connected to the host computer through a LAN or the Internet. Each host computer includes a browser for selecting data files and disk copiers through the network. The copying operations can be executed and completed by the remote host computer to copy data thereof to another remote copying unit via the network.

### BACKGROUND OF THE INVENTION

The present invention relates to a network copying system and, more particularly, to a network copying system, which enables the user to copy data from a host computer disk to a remote computer through a LAN (local area network) or the Internet. The invention relates also to the copying method used in the network copying system.

Following fast development of Internet technology, various network master-slave architectures have been disclosed for different purposes. Furthermore, when copying data from one computer disk to another, an independent CD-writer/disk copier Is needed, and, as this result, the capability of expansion is limited. At this point, there still no related inventions especially by means of network management for this copying data operation.

### SUMMARY OF THE INVENTION

It is therefore a primary objective of the present invention to provide an apparatus and a method for a network copying system, which enables the user to use a browser to monitor remote copying units and to select which data and which copying unit to be copied. Additionally, the present invention also provides users an apparatus and a method of a network copying system to copy data by just controlling their own remote computers through the network and to acknowledge users after the data copy operations have been completed.

In accordance with the claimed invention, a network copying system includes a host computer and at least one copying unit. The host computer includes a network interface, a host computer disk, and a browser. Data stored in the host computer disk are read and transmitted to a network through the network interface. The browser is to generate copying commands to the network by a network protocol, like the PPP, the HTTP, or the FTP network protocol. The copying unit receives the host computer disk data and the copying commands from the host computer. The copying unit is able to store the host computer disk data and execute copying operations after receiving the copying commands from the host computer.

It is an advantage of the present invention that enables the user to copy data to a computer recordable disk in a remote copying unit through a network. By means of the management through the network, users are able to copy data from their own computer devices to other remote computer devices through network connections. And, after the copying operations are completed, the copying units will send messages back to acknowledge users.

These and other objectives of the present invention will no doubt become obvious to those of ordinary skill in the art after reading the following detailed description of the preferred embodiment which is illustrated in the various figures and drawings.

### BRIEF DESCRIPTION OF THE DRAWINGS

FIG. 1 is a schematic diagram of illustrating a network copying system architecture according to the present invention.

FIG. 2 is a circuit block diagram of a copying unit for the network copying system according to the present invention.

FIG. 3 is an operational flow chart of the present invention.

FIG. 4 is a schematic diagram of illustrating a user interface according to the present invention.

### DETAILED DESCRIPTION OF THE PREFERRED EMBODIMENT

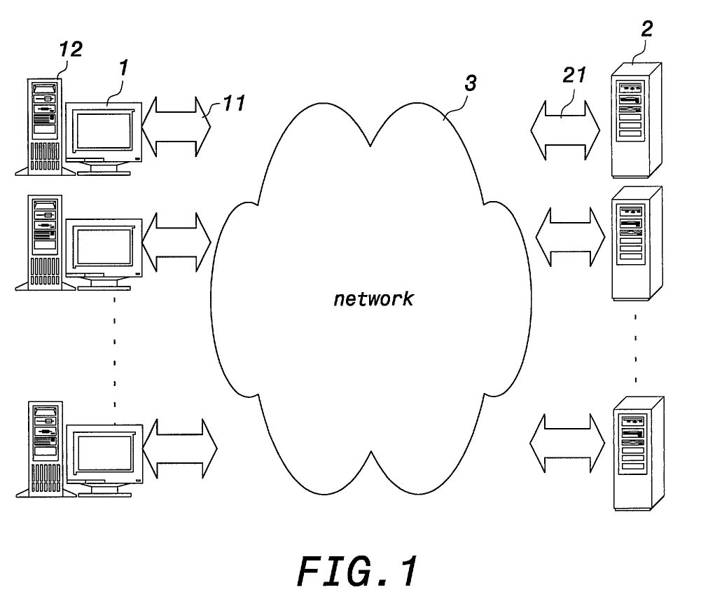

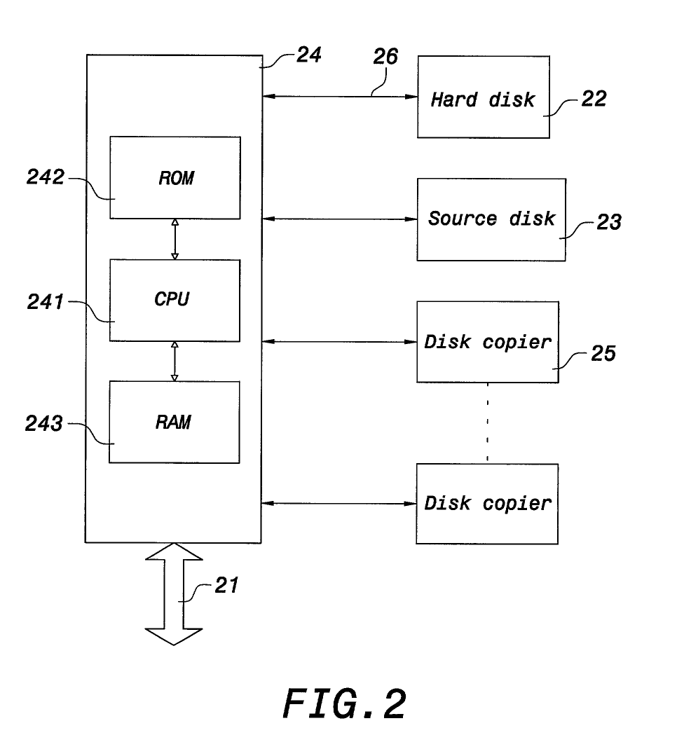

FIG. 1 shows the system architecture of the present invention. As illustrated, the network copying system includes at least one host computer 1 and at least one copying unit 2. Each of the host computers 1 has a built-in network interface 11 and a host computer disk 12, all connected with a network 3, which can be a LAN or an Internet. Please refer to FIG. 2 of a circuit block diagram of the copying unit for the present invention network copying system in conjunction with FIG. 1. The copying unit 2 includes a network interface 21, a hard disk 22, a source disk 23, a chipset 24, and at least one disk copier 25. The network interface 21, the hard disk 22, the source disk 23, the chipset 24, and the disk copier 25 connected with each other by an internal interface 26. The network interface 11 and 21 can be an Ethernet network interface. The internal interface 26 can be an IDE interface, a SCSI interface, an IEEE 1394 interface, a USB interface, an Ethernet interface, a fiber channel interface, or some other kinds of wireless interfaces. The host computer disk 12 can be a CD-ROM or a DVD-ROM.

The chip set 24 includes a CPU 241, a ROM 242, and a RAM 243. The chipset 24, connected to the network interface 21, receives the host computer data through the network interface 21, stores the host computer data to the hard disk 22 through the internal interface 26, and receives copying commands from the host computer 1. The disk copier 25 can be a CD-R, a CD-RW, a DVD-R, a DVD+RW, a DVD-RW, or a DVD-RAM. The disk copier 25 is driven by the chipset 24 to read the host computer data stored in the hard disk 22 and to copy the host computer data to a recordable disk of the disk copier 25. The host computer 1 is able to monitor the copying units 2 and execute copying operations through the network 3. Furthermore, the copying units 2 can write data to the disk copier 25 by the source disk 23, and the copying unit 2 itself can be embedded within the host computer 1.

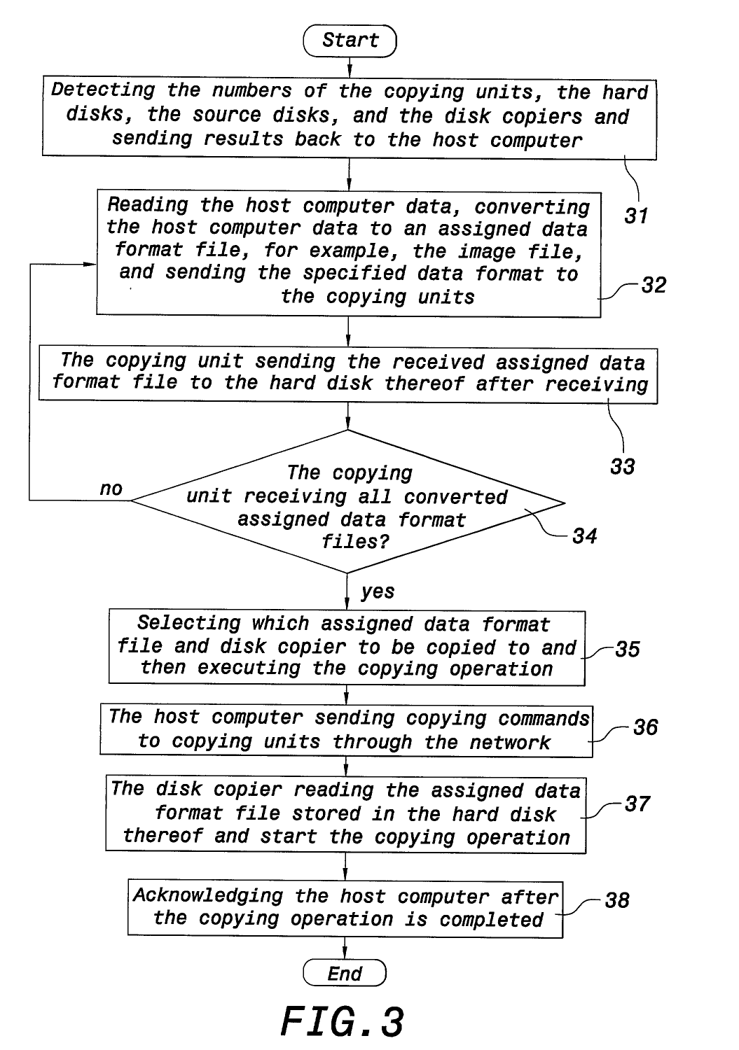

Referring to FIG. 3, the operation flow of the present invention includes the steps of:

step 31: detecting the numbers of the copying units, the hard disks, the source disks, and the disk copiers and sending results back to the host computer;

step 32: reading the host computer data, converting the host computer data to an assigned data format file, for example, an image file, and sending the assigned data format file to the copying units;

step 33: the copying unit sending the received assigned data format file to the hard disk thereof after receiving;

step 34: the copying unit receiving all converted assigned data format file? If yes, to step 35, if not, to step 32;

step 35: selecting which assigned data format file and which disk copier to be copied to and then executing the copying operation;

step 36: the host computer sending copying commands to copying units through the network;

step 37: the disk copier reading the specified data format stored in the hard disk thereof and start the copying operation;

step 38: acknowledging the host computer after the copying operation is completed;

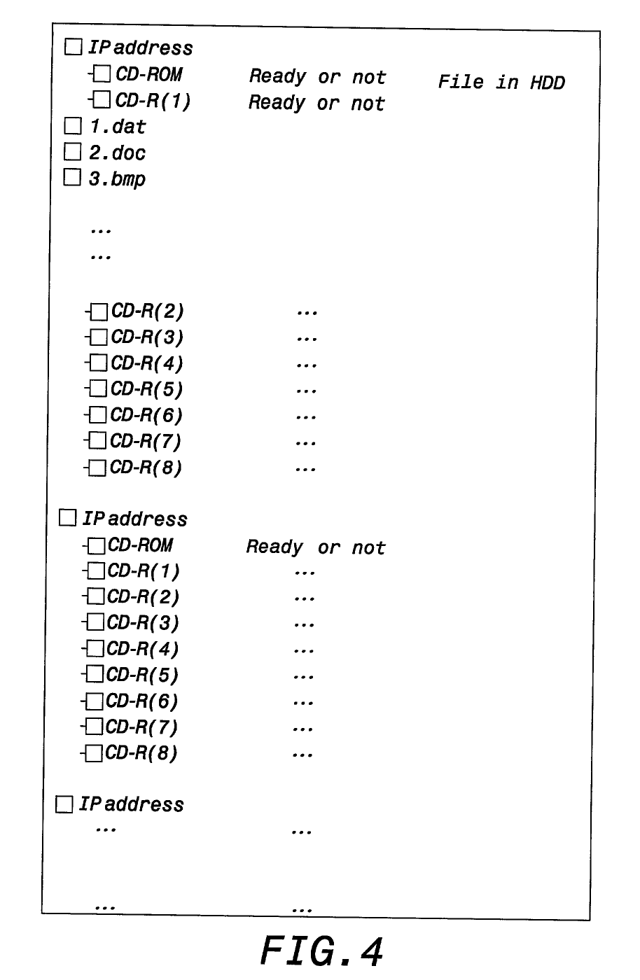

Furthermore, please refer to FIG. 4 of a schematic diagram of a user interface according to the present invention, users are able to select the disk copier according to its IP address through the browser in step 35. And, after selection, every assigned data format file stored in the hard disk will be shown to instruct user which assigned data format file is available to be copied. The user interface can be coded by the HTML text, thus it can be viewed by the browser.

In contrast to prior arts, the present invention provides a network copying system that enables users to monitor, to select copying units, and to execute copying operations through the browser. Additionally and most important of all, the copying operations can be completed by the network management, acknowledgements will be fed back to users after copying operations are completed.

Although particular embodiment of the inventions have been described in detail for purposes of illustration, various modifications and enhancements may be made without departing from the spirit and scope of the invention. Accordingly, the invention is not to be limited except as by the appended claims.

What the invention claimed is:

1. A network copying system comprising:
a network;
at least one host computer, each said host computer having a network interface connected to said network, a host computer disk, and a browser, said host computer reading data of said host computer disk and transmitting said host computer disk data to said network through said network interface, said browser generating copying commands to said network by a network protocol; and
at least one copying unit connected with said network, said copying unit receiving said host computer disk data, storing said host computer disk data, and executing a copying operation after receiving said copying commands.

2. The network copying system as claimed in claim 1, wherein said network interface is an Ethernet interface.

3. The network copying system as claimed in claim 1, wherein said network is a local area network.

4. The network copying system as claimed in claim 1, wherein said network is an Internet.

5. The network copying system as claimed in claim 1, wherein said copying unit has a hard disk, a source disk, a chipset, and at least one disk copier, said source disk reading disk data therein, said chipset connecting with said network through said network interface, receiving said host computer disk data and said copying commands, and copying said host computer disk data to said hard disk, said disk copier driven by said chipset for reading hard disk data and copying said hard disk data to a disk therein.

6. The network copying system as claimed in claim 5, wherein said hard disk, said source disk, said chipset, and said disk copier are connected by an internal interface.

7. A network copying method used in the network copying system of claim 5, comprising the steps of:
(a) detecting numbers of said copying unit, said hard disk, said source disk, and said disk copier and transmitting said numbers to said host computer;
(b) reading said host computer disk data, converting said host computer disk data into an assigned data format file, and sending said assigned data format file to said copying unit;
(c) said copying unit transmitting said assigned data format file to said hard disk thereof;
(d) selecting said assigned data format file and said disk copier to be copied and executing said copying operation after all said assigned data format file is received by said hard disk;
(e) said host computer transmitting said copying commands to said copying unit;
(f) said disk copier reading said assigned data format file and copying said assigned data format filed to said disk thereof;
(g) acknowledging said host computer that said copying operation is completed.

8. The network copying method as claimed in claim 7 wherein said chipset comprises a CPU (central processing unit), a ROM (read only memory), and a RAM (random access memory).

9. The network copying system as claimed in claim 1, wherein said network protocol is a PPP network protocol, a HTTP network protocol, or a FTP network protocol.
